(19) United States
(12) Patent Application Publication
(10) Pub. No.: US 2025/0095338 A1
(43) Pub. Date: Mar. 20, 2025

(54) DEVICE AND COMPUTER-IMPLEMENTED METHODS FOR MACHINE LEARNING, FOR PROVIDING A MACHINE LEARNING SYSTEM, OR FOR OPERATING A TECHNICAL SYSTEM

(71) Applicant: Robert Bosch GmbH, Stuttgart (DE)

(72) Inventors: Yumeng Li, Tuebingen (DE); Anna Khoreva, Stuttgart (DE); Dan Zhang, Leonberg (DE)

(21) Appl. No.: 18/802,764

(22) Filed: Aug. 13, 2024

(30) Foreign Application Priority Data
Sep. 20, 2023 (EP) 23 19 8631.6

(51) Int. Cl. G06V 10/774; G06T 9/00; G06V 10/764

(52) U.S. Cl. CPC G06V 10/774; G06T 9/00; G06V 10/764; G06V 2201/07

(57) ABSTRACT

A device and a computer-implemented method for machine learning. The method includes: providing a latent variable of a diffusion model representing the synthetic digital image, wherein providing the latent variable comprises sampling the latent variable from random noise, or providing a digital reference image, and adding noise with the diffusion model to the digital reference image to determine the latent variable, or mapping the digital reference image with an encoder to an input of the diffusion model, and adding noise with the diffusion model to the input to determine the latent variable, mapping the latent variable with the diffusion model depending on parameters of the diffusion model to features of the diffusion model, mapping the features with the diffusion model depending on parameters of the diffusion model to an output of the diffusion model.

### CROSS REFERENCE

The present application claims the benefit under 35 U.S.C. § 119 of European Patent Application No. EP 23 19 8631.6 filed on Sep. 20, 2023, which is expressly incorporated herein by reference in its entirety.

### FIELD

The present invention relates to a device and a computer-implemented methods for machine learning, for providing a machine learning system, or for operating a technical system.

### BACKGROUND INFORMATION

A diffusion model may be used in machine learning for generating synthetic digital images, e.g., for training, testing, verifying and/or validating the machine learning system depending on the synthetic digital image.

The diffusion model may be trained unconditional or conditional.

### SUMMARY

A device and the computer-implemented methods according to example embodiments of the present invention provide a machine learning with a diffusion model and a discriminator for providing guidance, wherein learning parameters of the diffusion model and/or the discriminator are learned depending on the guidance provided by the discriminator in the unconditional or conditional case. The diffusion model may be a neural network. The parameters of the diffusion model may be weights of the neural network resembling the diffusion model. The discriminator may be a neural network. The parameters of the discriminator may be weights of the neural network resembling the discriminator.

According to an example embodiment of the present invention, a computer-implemented method for machine learning, in particular for generating training and/or test data for training a machine learning system or for training an image classifier, comprises providing a latent variable of a diffusion model representing the synthetic digital image, wherein providing the latent variable comprises sampling the latent variable from random noise, or providing a digital reference image, and adding noise with the diffusion model to the digital reference image to determine the latent variable, or mapping the digital reference image with an encoder to an input of the diffusion model, and adding noise with the diffusion model to the input to determine the latent variable, wherein the method further comprises mapping the latent variable with the diffusion model depending on parameters of the diffusion model to features of the diffusion model, mapping the features with the diffusion model depending on parameters of the diffusion model to an output of the diffusion model, wherein the synthetic digital image comprises the output, or wherein the method comprises mapping the output with a decoder to the synthetic digital image, mapping the features or the synthetic digital image with a discriminator to a class, in particular either a class of a predetermined set of classes for a real digital image or a class for a synthetic digital image, depending on parameters of the discriminator, and learning at least one parameter of the diffusion model and/or the discriminator depending on a loss for the discriminator that is defined depending on the class and a predetermined reference class. The discriminator may be semantic segmentation network based, i.e., segmenter based. The discriminator provides the guidance for learning.

The synthetic digital image comprises pixels. According to an example embodiment of the present invention, the method may comprise determining the class pixel-wise, and learning the at least one parameter depending on a loss that defined depending on the pixel-wise classes and respective predetermined pixel-wise reference classes. This means the discriminator provides the guidance pixel-wise in particular for the unconditional diffusion model to improve local details.

According to an example embodiment of the present invention, the method may comprise determining a sequence of outputs comprising the output, wherein determining the sequence of outputs comprises determining a first output of the sequence depending on a result of encoding the input and decoding the encoded input, and successively determining a next output in the sequence depending on the result of encoding the output preceding the next output in the sequence and decoding the encoded output preceding the next output in the sequence, wherein encoding or decoding comprises determining the features. This means, the outputs and the features are determined in stages. discriminator may use features of the encoder or decoder at different stages.

According to an example embodiment of the present invention, the method may comprise determining, with a respective discriminator, the class for a plurality of outputs of the sequence depending on features collected from the respective encoding or decoding, and learning the parameters depending on the losses that are defined for the discriminators depending on the class predicted by the respective discriminator and the predetermined reference class. A discriminator per stage in the plurality of stages may be used for providing the guidance. Instead of training the diffusion model to predict noise at a single, randomly sampled stage during training, a multistep sampling at the plurality of stages takes into account several stages. The stages may be a number of successive stages, i.e., stages within a horizon defined by the number of stages.

According to an example embodiment of the present invention, the method may comprise predicting a noise in a next output of the sequence depending on the output preceding the next output in the sequence of outputs, and learning the parameters depending a loss for noise and depending on the losses that are defined for the discriminators, wherein the loss for noise is defined depending on the predicted noise and a predetermined random noise, in particular random noise sampled from a Gaussian distribution. This reduces the memory consumption compared to using the loss for noise at several stages.

According to an example embodiment of the present invention, the method may comprise providing a condition, in particular a label map, modulating the features depending on the condition and mapping the modulated features with the diffusion model to the output, and/or with the discriminator to the class. The label map for example comprises a pixel-wise reference class for the pixel of the synthetic digital image. The implicit assumption is that the conditional information is beneficial for the noise prediction in the diffusion model, thus the denoising will learn to use the condition. With the discriminator there is explicit enforcement or supervision for the usage of condition.

According to an example embodiment of the present invention, the method may comprise learning the parameters depending on the loss that is defined for the discriminator, wherein the loss that is defined for the discriminator is defined depending on the condition, or learning the parameters depending on the losses that are defined for the discriminators, wherein the losses are defined depending on the condition. In the conditional case, additional guidance is provided that depends on the condition.

This discriminator provides in particular pixel-wise guidance and encourages the conditional alignment. The discriminator may be trained jointly with the diffusion model, and learns to predict the given label map condition on real samples and predict fake ones as the additional “fake” class. The diffusion model learns to generate realistic images aligned with the label map as synthetic digital images to fool the discriminator. In this way, the label map condition is explicitly leveraged during training.

The condition comprises the predetermined reference class or the pixel-wise reference classes, e.g., the label map, to provide the additional guidance.

A computer-implemented method for providing the machine learning system, in particular a neural network for semantic segmentation, object recognition, or classification of objects, comprises generating a synthetic digital image with the method for machine learning, and training, testing, verifying, or validating the machine learning system for semantic segmentation, or object recognition, or classification of objects, preferably for recognizing background or an object, in particular a traffic sign, a road surface, a pedestrian, a vehicle, an animal, a plant, infrastructure, or the sky, depending on the synthetic digital image.

Training the machine learning system may comprise providing the condition, in particular the label map that is provided for generating the synthetic digital image as ground truth for training the machine learning system.

A computer-implemented method for operating a technical system, in particular a computer-controlled machine, preferably a robotic system, a vehicle, a domestic appliance, a power tool, a manufacturing machine, a personal assistant or an access control system, comprises providing the machine learning system with the method for providing the machine learning system, capturing a digital image with a sensor, in particular a video, radar, LiDAR, ultrasonic, motion, or thermal image, and determining a control signal for operating the technical system with the machine learning system depending on the digital image.

A device may comprise at least one processor and at least one memory, wherein the at least one processor is configured to execute instructions that, when executed by the at least one processor, cause the device to execute the method for machine learning, for providing the machine learning system or operating the technical system, wherein the at least one memory is configured to store the instructions.

A computer program, characterized in that the computer program comprises computer-readable instructions that, when executed by a computer, cause the computer to execute the method according to the present invention disclosed herein.

Further advantageous embodiments of the present invention are derived from the following description and the figures.

### BRIEF DESCRIPTION OF THE DRAWINGS

FIG. 1 schematically depicts a device, according to an example embodiment of the present invention.

FIG. 2 schematically depicts an exemplary diffusion model, according to the present invention.

FIG. 3 schematically depicts a feature-based discriminator, according to an example embodiment of the present invention.

FIG. 4 schematically depicts an image-based discriminator, according to an example embodiment of the present invention.

FIG. 5 schematically depicts a sequence of denoising stages of the diffusion model, according to an example embodiment of the present invention.

FIG. 6 schematically depicts the sequence of denoising stages for remove the noise depending on a condition, according to an example embodiment of the present invention.

FIG. 7 schematically depicts a flow chart of a first example embodiment of a method for generating a synthetic digital image, according to the present invention.

FIG. 8 schematically depicts a flow chart of a second example embodiment of the method for generating a synthetic digital image, according to the present invention.

FIG. 9 schematically depicts a flow chart of a third example embodiment of the method for generating a synthetic digital image, according to the present invention.

### DETAILED DESCRIPTION OF EXAMPLE EMBODIMENTS

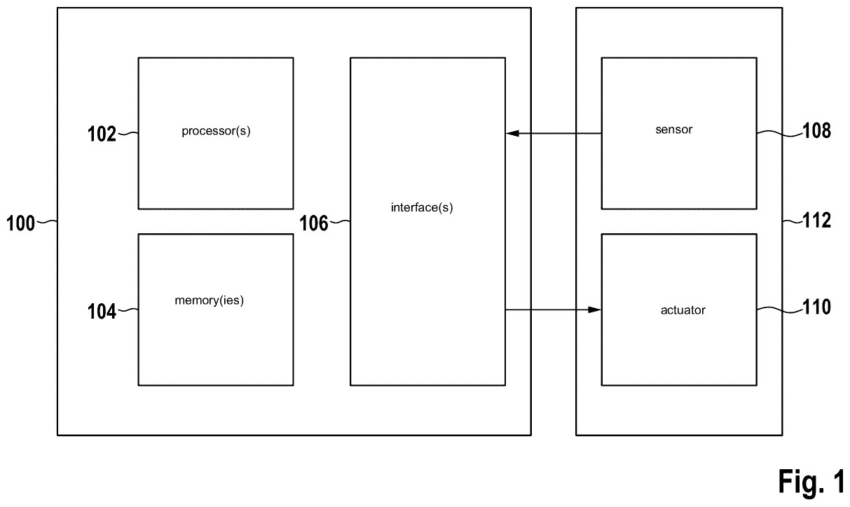

FIG. 1 depicts schematically a device 100.

The device 100 comprises at least one processor 102 and at least one memory 104. The at least one memory 104 comprises at least one non-transitory memory. The at least one memory 104 is configured to store instructions that are executable by the at least one processor 102 and that cause the device 100 to perform a method for generating a synthetic digital image, when executed by the at least one processor 102.

The synthetic digital image may be a video, radar, LiDAR, ultrasonic, motion, or thermal image.

The device 100 may be configured to read a digital reference image from storage. The digital reference image may be a video, radar, LiDAR, ultrasonic, motion, or thermal image.

The device 100 may comprise at least one interface 106. The at least one interface 106 may be configured for receiving the digital reference image, e.g., from a sensor 108. The at least one interface 106 may be configured to output a control signal for an actuator 110.

The sensor 108 may be configured to capture a video, radar, LiDAR, ultrasonic, motion, or thermal image.

The sensor 108 or the actuator 110 may be part of a technical system 112. The technical system 112 is a physical system. The technical system 112 may be a computer-controlled machine, preferably a robotic system, a vehicle, a domestic appliance, a power tool, a manufacturing machine, a personal assistant or an access control system.

The device 100 may comprise a machine learning system that is configured to operate the technical system 112 depending on input from the sensor 108 and with output of the control signal to the actuator 110.

For example, the machine learning system is configured to determine the control signal for operating the technical system 112 depending on a digital image.

The digital image may be a video, radar, LiDAR, ultrasonic, motion, or thermal image.

Determining the control signal depending on the digital image for example comprises mapping the digital image with a neural network for semantic segmentation, object recognition or classification of objects.

Determining the control signal depending on the digital image for example comprises determining the control signal depending on an output of the neural network, e.g., the semantic segmentation, object recognition, or classification of objects.

For example, a background is distinguished from objects, or recognized, or classified as background in the digital image or an object is distinguished from background, or recognized, or classified, e.g., as a traffic sign, a road surface, a pedestrian, a vehicle, an animal, a plant, infrastructure, or the sky, depending on the synthetic digital image.

For example, the control signal is determined to move the technical system 112 upon recognizing or classifying the object as a predetermined object indicating that moving the technical system 112 is acceptable or stopping the technical system 112 otherwise or upon recognizing or classifying the object as a predetermined object indicating that stopping the technical system 112 is required.

Classifying the object may comprise segmentation and/or object detection.

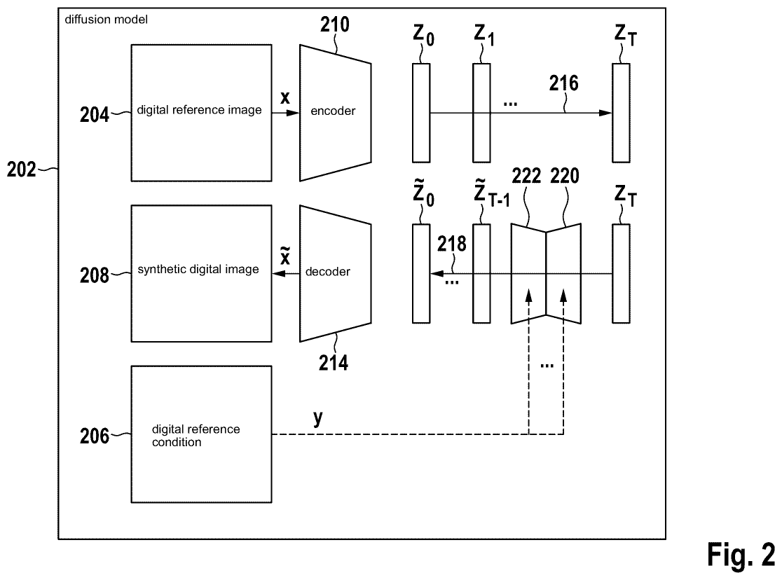

FIG. 2 schematically depicts an exemplary diffusion model 202.

The diffusion model 202 is configured to receive a digital image x, e.g., a digital reference image 204, in an image space, and to determine an output \tilde{x}, e.g., a synthetic digital image 208, in the image space. The digital image x and/or the digital reference image 204 and/or the synthetic digital image 208 may be a video, radar, LiDAR, ultrasonic, motion, or thermal image. Optionally, the diffusion model 202 is configured to receive a condition y, e.g., a digital reference condition 206, and to determine the output k depending on the condition y and the digital image x.

The diffusion model 202 comprises an encoder 210 that is configured to encode the input x, e.g., the digital reference image 204, into a representation Z₀, e.g., of the digital reference image 204, in a latent space of the diffusion model.

The diffusion model 202 comprises a decoder 214 that is configured to decode a representation \tilde{Z}₀, e.g., of the synthetic digital image 208, in the latent space to the output \tilde{x}, e.g., the synthetic digital image 208, in the image space.

The image space in the example is a pixel space, e.g., for a RGB image comprising a width W, a height H and 3 channels. The image space may comprise more or less channels.

The diffusion model 202 is configured to successively add in a forward pass 216 random noise to the representation Z₀ in the latent space. In the example, the diffusion model according to the first embodiment 202 is configured to determine a sequence Z₁, . . . , Z_{T} of representations, wherein after the first representation Z₀ a next representation Zₜ₊₁ in the sequence is determined depending on the result of adding random noise to the representation Zₜ preceding the next representation Zₜ₊₁ in the sequence of representations.

The diffusion model 202 is configured to successively remove in a denoising process 218 random noise from the last representation Z_{T} in the latent space. In the example, the exemplary diffusion model 202 is configured to determine a sequence \tilde{Z}_{T-1}, . . . , \tilde{Z}₀ of outputs depending on the last representation Z_{T} as input to the denoising process. A first output \tilde{Z}_{t=T-1} in the sequence is determined in the example by denoising the input Z_{T}. After the first output \tilde{Z}_{t=T-1} a next output \tilde{Z}ₜ₋₁ in the sequence is determined depending on the result of denoising the output \tilde{Z}ₜ preceding the next output \tilde{Z}ₜ₋₁ in the sequence of outputs.

The diffusion model 202 is configured to determine the first output \tilde{Z}_{t=T-1} depending on a result of encoding the input Z_{T} with an encoder 220 and decoding the encoded input with a decoder 222.

The diffusion model 202 is configured to determine the respective next output \tilde{Z}ₜ₋₁ depending on a result of encoding the output \tilde{Z}ₜ preceding the next output \tilde{Z}ₜ₋₁ with an encoder and decoding the encoded input with a decoder.

A respective encoder is configured to determine features of the encoder at different levels of the encoder. A respective decoder is configured to determine features of the decoder at different levels of the decoder.

The diffusion model 202 is optionally configured to manipulate the features depending on the condition y. The diffusion model 202 is for example configured to manipulate the features of one encoder or multiple encoders or the features of one decoder or multiple decoders. The diffusion model 202 is for example configured to manipulate the features at at least one level or at different levels. The diffusion model 202 is for example configured to input the condition y to the encoder or decoder at the level or at the respective levels. According to the example, the features of a respective encoder are manipulated depending on the condition y only or depending on the condition y and the features of the same encoder. According to the example, the features of a respective decoder are manipulated depending on the condition y only or depending on the condition y and the features of the same decoder.

An example for the diffusion model is a stable diffusion model that operates in a latent space of an autoencoder.

Firstly, an encoder ε, i.e., the encoder 210, maps a given image x, e.g., the digital reference image 204, into a spatial latent code Z₀=ε(x), then \tilde{Z}₀ is mapped back to a prediction for the image \tilde{x}, e.g., the synthetic digital image 208, in the image space by a decoder D, i.e., the decoder 214. According to an example, the autoencoder is trained to reconstruct the given image, i.e., \tilde{x}=D(ε(x)).

Secondly, the forward pass 216 and the denoising process 218 of the diffusion model are trained in the latent space.

The forward pass is a Markov chain to gradually add Gaussian noise to the spatial latent code Z₀:

$$q ( {z}_{t} \vert {z}_{t - 1} ) = N ( {z}_{t} ; \sqrt{1 - {β}_{t}} {z}_{t - 1} , {β}_{t} I )$$

where {βₜ}ₜ₌₀^{T} are a fixed variance schedule. The noisy latent code Z_{T} is computed successively:

$${Z}_{t} = \sqrt{{α}_{t}} {Z}_{0} + \sqrt{1 - {α}_{t}} ϵ$$

where ε˜N(0, I), where Z₀=ε(x), and αₜ:=Πₛ^{t}(1−βₛ).

The reverse denoising process 218 is parametrized in the example by another Gaussian distribution

$${p}_{θ} ( {z}_{t - 1} \vert {z}_{t} ) := N ( {z}_{t - 1} ; {μ}_{θ} ( {z}_{t} , t ) , {σ}_{θ} ( {z}_{t} , t ) )$$

Essentially μ_{θ}(zₜ,t) is expressed as a linear combination of zₜ and predicted noise ϵ_{θ(z}_{ₜ}_{,t)} which is modeled for example by the encoder and decoder that are configured to map the preceding output zₜ to the next output zₜ₋₁.

In an example, the respective encoder and the respective decoder are implemented as a UNet. UNet is described e.g., in Olaf Ronneberger, Philipp Fischer, Thomas Brox, “U-Net: Convolutional Networks for Biomedical Image Segmentation,” 18 May 2015, https://arxiv.org/abs/1505.04597.

The parameters of the encoder and decoder are learned in the example by minimizing the L2 norm of the noise prediction at a sampled timestep t:

$${L}_{n o i s e} = {E}_{z ∼ ε ( x ) , ϵ ∼ N ( 0 , I ) , t} [ {‖ ϵ - {ϵ}_{θ} ( {z}_{t} , t ) ‖}^{2} ]$$

In case the optional condition y is used, in the training, or after an initial training of the diffusion model, the modulation of the features depending on the condition y may be trained with a loss

$${L}_{n o i s e} = {E}_{z ∼ ε ( x ) , ϵ ∼ N ( 0 , I ) , t} [ {‖ ϵ - {ϵ}_{θ} ( {z}_{t} , t , y ) ‖}^{2} ]$$

that depends on the condition y.

The diffusion model 202 may be configured to control the features of at least one of the decoders. The diffusion model 202 may comprise a trainable copy of the encoder that precedes the decoder that is controlled. The diffusion model 202 may be configured to provide the condition y to a convolution, in particular a zero convolution, and to provide a result of adding the convolved condition to the preceding output zₜ as input to the trainable copy of the encoder. The diffusion model 202 may be configured to provide the output of the trainable copy of the encoder to a convolution, in particular a zero convolution. The diffusion model 202 may be configured to manipulate the features of the decoder at one level depending on the output of the convolution. The diffusion model 202 may be configured to propagate the output of the trainable copy of the encoder through a series of convolutions, in particular zero convolutions and manipulate the features of the decoder at different levels depending on the output of a respective convolution of the series. Propagate means for example, that the output of a convolution is used as input for a next convolution in the series.

Zero convolution in this context refers to a convolution that comprises parameters, weight and bias, that are initialized as zeros before training the diffusion model and that are learned in training. In the example, the zero convolution is a 1×1 convolution. Trainable copy of the encoder refers to an encoder that comprises parameters that are initialized before training of the trainable copy with the values of the parameters of the encoder. In training of the trainable copy, the parameters of the encoder are frozen, i.e., remain unchanged, and the parameters of the trainable copy are learned.

The output of the convolutions and the trainable copy of the encoder is for example integrated in the diffusion model 202 as ControlNet, wherein the features of the trainable copy of the encoder are manipulated.

The diffusion model 202 may be configured to modulate the features of the trainable copy in the same way as described for the encoder of the diffusion model 202.

According to an example, the layers for modulating the features, e.g., the SPADE blocks, are inserted at predetermined locations of the trainable copy, e.g., UNet, an modulate the features of the trainable copy as described for the modulation of the features in the diffusion model 202.

The features f may be manipulated depending on the condition y in different ways.

The according to a first exemplary modulation, a SPADE block takes the conditional input y and extracted features f from a level of the frozen diffusion network, and outputs spatially modulated features f_{adp}, e.g., as

$${f}_{adp} = \frac{f - {μ}_{f}}{{γ}_{f}} γ ( y ) + μ ( y )$$

where μ_{f} is the mean and γ_{f} is the standard deviation of the extracted features f, and where μ(y) and γ(y) are learned pixel-wise modulation parameters conditioned on the condition y. The SPADE block is for example configured as described in, Taesung Park, Ming-Yu Liu, Ting-Chun Wang, Jun-Yan Zhu, “Semantic Image Synthesis with Spatially-Adaptive Normalization”, 5 Nov. 2019, https://arxiv.org/abs/1903.07291.

According to an example, the modulated features f_{adp} and the extracted features f are added to an output fₒᵤₜ that replaces the extracted features f at the original level, i.e., f←fₒᵤₜ=f_{adp}+f.

The modulated features f_{adp} may be inserted to replace the extracted features f at the original level, i.e., f←fₒᵤₜ=f_{adp}, or inserted at another level, e.g., a level that is after the original level in direction of the denoising process 218. The diffusion model 202 of the diffusion model may be configured to replace features f at a level with features fₒᵤₜ=f+tanh(β)f_{adp}, where β is a learnable factor and initialized e.g., as zero. This means, the modulated features f_{adp} are added to f in a learnable way.

The diffusion model 202 may comprise a sequence of a self-attention layer, a cross attention layer and a feed forward layer. According to a second exemplary modulation the features f are extracted from an output of the cross-attention layer of the diffusion model that follows after the self-attention layer of the diffusion model in direction of the denoising process 218, and provided as input to the SPADE block and as input to the feed forward layer of the diffusion model. The features are modulated depending on an output of the SPADE block as described for the first exemplary modulation.

The diffusion model 202 may comprise one or several of the parts for modulating features.

For example, SPADE blocks are inserted in parts of the diffusion model according to the first exemplary modulation or the second exemplary modulation at one predetermined location or at multiple predetermined locations of UNet or any other architecture of the diffusion model.

At inference time, the input z_{T} for the denoising process 218 is randomly sampled from the Gaussian distribution and the condition y is provided. Then the trained denoising encoder and decoder sets, e.g., the UNet, are sequentially applied, to obtain the denoised latent zₜ₋₁ given zₜ from to t=T to t=1, while the features are manipulated depending on the condition y. The final synthesized image can be obtained by feeding the clean latent space code \tilde{Z}₀ through the decoder D:

$$\tilde{x} = D ( {\tilde{Z}}_{0} )$$

The diffusion model 202 comprises trainable parameters.

A discriminator or discriminators may be used for training the diffusion model 202. The training may use explicit supervision of the condition y.

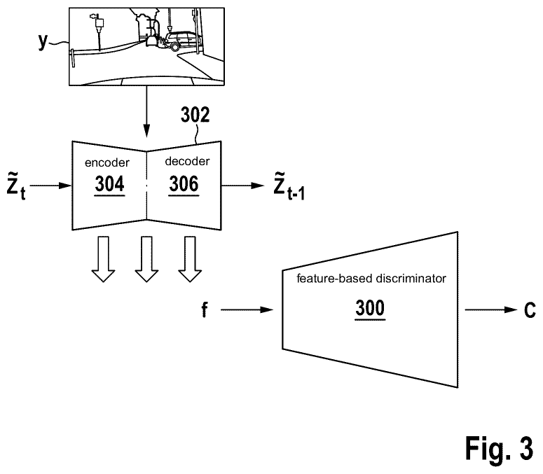

FIG. 3 schematically depicts an exemplary feature-based discriminator 300 and a first denoising stage 302 for the diffusion model 202 that is configured to determine the respective next output \tilde{Z}ₜ₋₁ depending on a result of encoding the output \tilde{Z}ₜ preceding the next output \tilde{Z}ₜ₋₁ with an encoder 304 of the first denoising stage 302 and decoding the encoded input with a decoder 306 of the first denoising stage 302.

The first denoising stage 302 is configured to output features f of the encoder 304 and/or the decoder 306 of the first denoising stage 302 to the feature-based discriminator 300.

The first denoising stage 302 is configured to manipulate the features f in the encoder 304 and/or the decoder 306 of the first denoising stage 302 as described above and to output the manipulated features f to the feature-based discriminator 300.

The feature-based discriminator 300 is configured to map the features f that are provided to the feature-based discriminator 300 by the first denoising stage 302 to a class c, in particular either a class of a predetermined set of N classes for a real digital image or a class for a synthetic digital image. In the example, the feature-based discriminator 300 is configured to determine the class pixel-wise.

The first denoising stage 302 may be configured to output an attention map depending on the output \tilde{Z}ₜ. The feature-based discriminator 300 may be configured to map the attention map received from denoising stage 302 and the features f to the class c or the pixel-wise class c.

Using the condition y is optional. In an unconditional case, i.e., without input of the condition y to the first denoising stage 302, the feature-based discriminator 300 may be trained to minimize the loss

$${L}_{seg} = - {\sum }_{i , j} log [ {y}_{pred , i , j} ] , {y}_{pred} = Dis ( {f}_{t} ) , {y}_{pred} ∈ \{ 0 , 1 \}$$

wherein y_{pred} is the prediction, Dis(fₜ) represents the mapping function of the feature-based discriminator 300, wherein i,j indicates a spatial location, the prediction y_{pred}=0 represents a fake class and the prediction y_{pred}=1 represents a real class, and L_{seg} represents the per-pixel binary cross-entropy loss with the ground truth label as 1 everywhere.

A loss for the conditional case, i.e., wherein the diffusion model 202 uses the condition y, e.g., an input map, is for example:

$${L}_{seg} = CE ( y , {y}_{pred} ) = - {\sum }_{c = 1}^{N} {α}_{c} {\sum }_{i , j} {y}_{i , j} log {y}_{pred , i , j} , {y}_{p r e d} = D i s ( {f}_{t} ) , {y}_{pred}$$

$$∈ \{ , … , N , N + 1 \}$$

$${α}_{c} = \frac{H \times W}{{\sum }_{i , j}^{H \times W} {E}_{y} [ I [ {y}_{i , j , c} = 1 ] ]}$$

where CE represents the cross-entropy loss, wherein the prediction y_{pred} includes N real sematic classes (1, . . . , N) and 1 fake class (N+1). Since the class frequency is usually imbalanced, the example comprises a class balancing weight α_{c}, which for example is an inverse pixel-wise frequency of a class c per batch that depends on the height H, the width W and the expectancy value for the unit matrix I for the predictions y_{i,j,c}=1 i.e., being real classes. During training, e.g., due to memory constraint, a limited number of images, e.g., 8 images, are sampled as batch per optimization step. For the limited number of 8 images, one training batch contains 8 images.

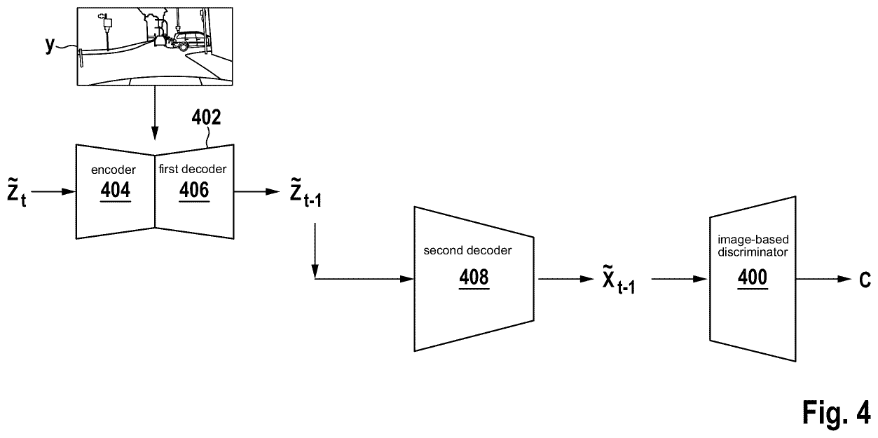

FIG. 4 schematically depicts an exemplary image-based discriminator 400 and a second denoising stage 402 for the diffusion model 202 that is configured to determine the respective next output \tilde{Z}ₜ₋₁ depending on a result of encoding the output \tilde{Z}ₜ preceding the next output \tilde{Z}ₜ₋₁ with an encoder 404 of the second denoising stage 402 and decoding the encoded input with a first decoder 406 of the second denoising stage 402. The second denoising stage 402 is configured to provide the next output \tilde{Z}ₜ₋₁ to a second decoder 408 of the second denoising stage 402 that is configured to map the next output \tilde{Z}ₜ₋₁ to a digital image \tilde{x}ₜ₋₁.

The second denoising stage 402 is configured to manipulate the features f in the encoder 404 and/or the decoder 406 of the second denoising stage 402 as described above.

The image-based discriminator 400 is configured to map the next output \tilde{Z}ₜ₋₁ that is provided to the image-based discriminator 400 by the second denoising stage 402 to a class c, in particular either a class of a predetermined set of N classes for a real digital image or a class for a synthetic digital image. In the example, the image-based discriminator 400 is configured to determine the class pixel-wise.

Using the condition y is optional. In an unconditional case, i.e., without input of the condition to the second denoising stage 402, the image-based discriminator 400 may be trained to minimize the loss

$${L}_{seg} = - {\sum }_{i , j} log [ {y}_{pred , i , j} ] , {y}_{p r e d} = Dis ( {\tilde{x}}_{t} ) , {y}_{p r e d} ∈ \{ 0 , 1 \}$$

wherein Dis(\tilde{x}ₜ) represents the mapping function of the image-based discriminator 400, wherein i,j indicates a spatial location, the prediction y_{pred}=0 represents a fake class and the prediction y_{pred}=1 represents a real class, and L_{seg} represents the per-pixel binary cross-entropy loss with the ground truth label as 1 everywhere.

The diffusion model 202 may comprise multiple first denoising stages 302 or multiple second denoising stages 402. The diffusion model 202 may comprise a first denoising stage 302 or multiple first denoising stages 302 and a second denoising stage 402 or multiple second denoising stages 402.

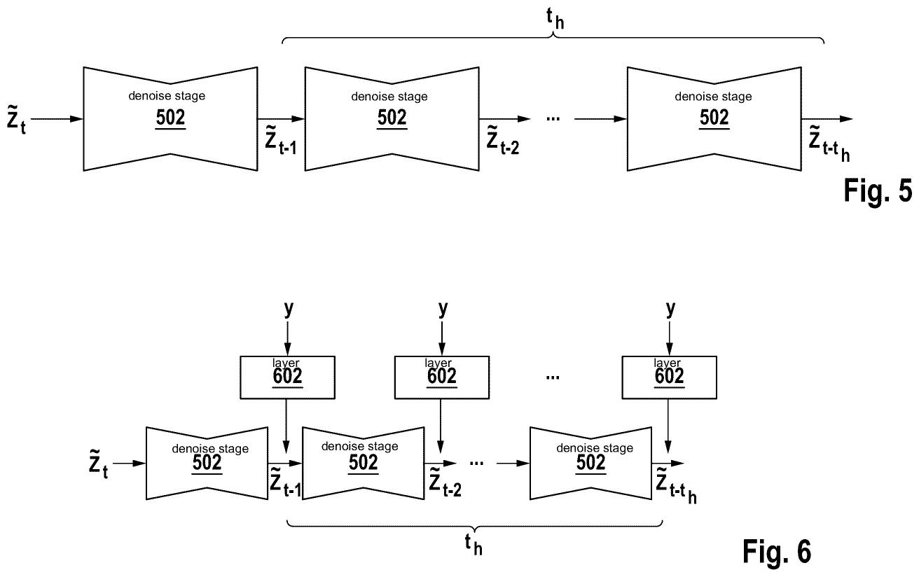

FIG. 5 schematically depicts a sequence of denoising stages 502 that are arranged in the diffusion model 202 to successively remove noise from output \tilde{Z}ₜ at different steps t within a horizon tₕ. This means, the diffusion model 202 is configured to determine the sequence of outputs \tilde{Z}ₜ₋₁, \tilde{Z}ₜ₋₂, . . . , \tilde{Z}ₜ_{ₕ} within the horizon tₕ.

For example, the diffusion model 202 is trained depending on a respective loss L_{seg} for the output \tilde{Z}ₜ and for the sequence of outputs \tilde{Z}ₜ₋₁, \tilde{Z}ₜ₋₂, . . . , \tilde{Z}ₜ_{ₕ} and the loss Lₙₒᵢₛₑ for the output \tilde{Z}ₜ, e.g., with the loss

$$L = {L}_{n o i s e} + λ {\sum }_{i} {L}_{seg , i} , i = t , … , t - 1 - {t}_{h}$$

wherein λ is an optional weighting factor. To avoid memory explosion, only gradients of the first step t, i.e., Lₙₒᵢₛₑ, may be used, while the discriminator loss L_{seg} may be determined at the following steps t−1, . . . , t−1−tₕ.

FIG. 6 schematically depicts the sequence of denoising stages 502 that are arranged in the diffusion model 202 to successively remove noise from output \tilde{Z}ₜ depending on the condition y at different steps t within a horizon tₕ. The condition is in the example mapped with a layer 602 to a representation of the condition y that is added to the respective output in the sequence of outputs \tilde{Z}ₜ₋₁, \tilde{Z}ₜ₋₂, . . . , \tilde{Z}ₜ_{ₕ}.

The layer 602 may be configured to map the condition y, e.g., the label map pixel-wise to determine a modified noise prediction:

$${ϵ}_{mod}^{t} = \frac{{ϵ}_{θ}^{t} ( {z}_{t} , t , y ) - {μ}_{ϵ}}{{γ}_{ϵ}} γ ( y ) + μ ( y )$$

where μ_{ϵ} is the mean and γ_{ϵ} is the standard deviation of the original noise prediction ϵ_{θ}^{t} and γ(y) and μ(y) are the learned modulation parameters conditioned on the input condition y.

A corresponding training strategy for the diffusion model 202 improves the synthesis quality and is particularly useful for the conditional diffusion model 202, i.e., the diffusion model 202 using the condition y to enhance the conditional alignment.

The discriminator provides per-pixel guidance without using the condition or per-pixel conditional guidance when using the condition y. The multistep sampling of losses in the horizon during training further improves the training. Especially for the conditional case, i.e., when using the condition y, the inter-step conditioning strengthens the conditional effect.

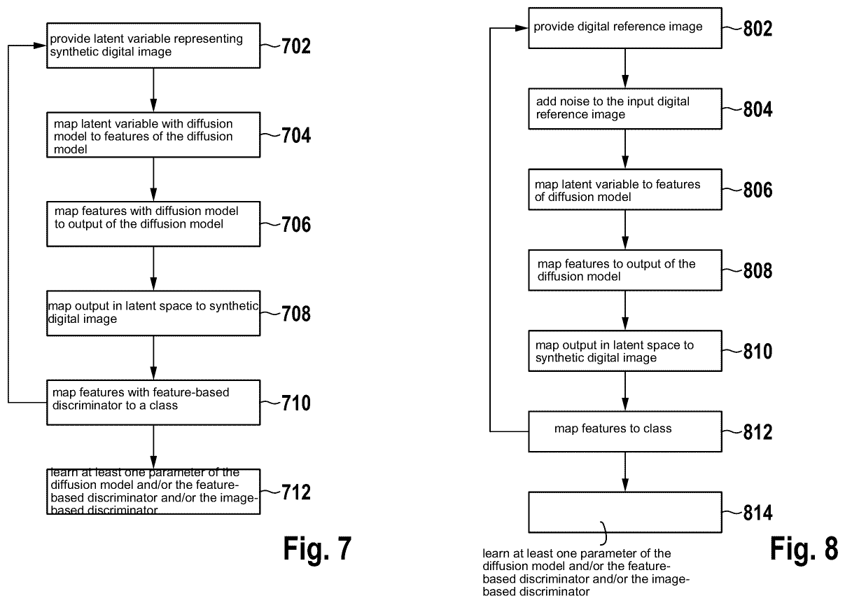

FIG. 7 schematically depicts a flow chart of a first embodiment of a method for generating a synthetic digital image. According to the first embodiment, the diffusion model 202 is used for inference.

The method comprises a step 702.

The step 702 comprises providing a latent variable Z_{T} of the diffusion model 202 representing the synthetic digital image \tilde{x}.

The latent variable Z_{T} is sampled from random noise.

The inference may use the condition y or not.

In the conditional case, i.e., when the condition y is used, the step 702 comprises providing the condition y.

The condition y is for example the label map.

The method comprises a step 704.

The step 704 comprises mapping the latent variable Z_{T} with the diffusion model 202 depending on parameters of the diffusion model 202 to features f of the diffusion model 202.

The step 704 may comprise determining the sequence of outputs Z_{T-1}, . . . Z₀ comprising the output Z₀.

Determining the sequence of outputs \tilde{Z}_{T-1}, . . . \tilde{Z}₀ may comprise determining a first output \tilde{Z}_{T-1} of the sequence depending on a result of encoding the input Z_{T} and decoding the encoded input, and successively determining a next output \tilde{Z}_{T-2}, . . . \tilde{Z}₀ in the sequence depending on the result of encoding the output \tilde{Z}_{T-1}, . . . \tilde{Z}₁ preceding the next output \tilde{Z}_{T-2}, . . . \tilde{Z}₀ in the sequence and decoding the encoded output preceding the next output in the sequence.

Encoding or decoding may comprise determining the features f.

The step 704 comprises predicting a noise ϵᵢ in a next output \tilde{Z}ᵢ of the sequence \tilde{Z}_{T-2}, . . . \tilde{Z}₀ depending on the output \tilde{Z}_{T-1}, . . . \tilde{Z}₁ preceding the next output \tilde{Z}ᵢ₋₁ in the sequence of outputs \tilde{Z}_{T-1}, . . . \tilde{Z}₀.

The method comprises a step 706.

The step 706 comprises mapping the features f with the diffusion model 202 depending on parameters of the diffusion model 202 to an output Z₀ of the diffusion model 202.

The step 706 may comprise modulating the features f depending on the condition y as described above and mapping the modulated features f with the diffusion model 202 to the output Z₀.

The output Z₀ may be in image space, i.e., pixel space, or in latent space.

The method may comprise a step 708 for mapping the output Z₀ in latent space to the synthetic digital image \tilde{x}.

The synthetic digital image \tilde{x} may comprise the output Z₀ in image space. This means, no decoder 214 is used.

For training, validation, or verification, the method may comprise a step 710.

The step 710 may comprise mapping the features f with the feature-based discriminator 300 to a class c.

The step 710 may comprise mapping the synthetic digital image \tilde{x} with the image-based discriminator 400 to the class c.

The class c is either a class of the predetermined set of N classes for the real digital image or the class for the fake digital image, i.e., recognition of a synthetic digital image \tilde{x}.

The method may comprise determining the class pixel-wise.

The step 710 may comprise determining the class c for a plurality of outputs of the sequence Z_{T-1}, . . . Z₀ with a respective discriminator depending on features f_{T-1}, . . . f₀ collected from the respective encoding or decoding.

The method comprises a step 712.

The step 712 comprises learning at least one parameter of the diffusion model 202 and/or of the feature-based discriminator 300 and/or of the image-based discriminator 400 depending on the loss L_{Seg}.

For the unconditional case, in the loss L_{Seg} the prediction y_{pred}=0 represents a fake class and the prediction y_{pred}=1 represents a real class. For the conditional case, in the loss L_{Seg} one prediction represents a fake class and N prediction represent true classes. For example, the prediction y_{pred} for N real sematic classes (1, . . . , N) and 1 fake class (N+1) is used as described above.

This means, the loss L_{Seg} for the discriminator is defined depending on the class c and a predetermined reference class or the pixel-wise classes and pixel-wise reference classes.

In the conditional case, the condition y may comprise the predetermined reference class or the pixel-wise reference classes.

The step 712 may comprise learning the parameters depending on the losses L_{Seg,i} that are defined for the discriminators depending on the class c predicted by the respective discriminator and the predetermined reference class.

The step 712 may comprise learning the parameters depending the loss for noise Lₙₒᵢₛₑ and depending on the losses L_{Seg} that are defined for the discriminators.

The loss for noise Lₙₒᵢₛₑ is defined depending on the predicted noise ϵᵢ and a predetermined random noise, in particular random noise sampled from a Gaussian distribution.

The loss L_{Seg} that is defined for the discriminator or the losses L_{Seg} that are defined for the discriminators may be the loss L_{Seg} that is defined depending on the condition y.

The reference class may be provided pixel-wise.

The method may comprise learning the at least one parameter depending on the loss that is defined depending on the pixel-wise classes and respective predetermined pixel-wise reference classes.

The steps 702 to 710 may be repeated to determine a batch of training data for learning the parameters. The step 712 may comprise learning the parameters e.g., with a gradient descent based on the batch of training data.

FIG. 8 schematically depicts a flow chart of a second embodiment of the method for generating a synthetic digital image. According to the second embodiment, the diffusion model 202 is configured to process a digital image as input x, i.e., without the encoder 210.

The method according to the second embodiment comprises a step 802.

The step 802 comprises providing a digital reference image 204.

The method according to the second embodiment comprises a step 804.

The step 804 comprises adding noise with the diffusion model 202 to the input x, i.e., the digital reference image 204 to determine the latent variable Z_{T}.

The method according to the second embodiment comprises a step 806.

The step 806 comprises mapping the latent variable Z_{T} as described in step 704.

The step 806 may comprise determining the sequence of outputs Z_{T-1}, . . . Z₀ as described in step 704, wherein encoding or decoding may comprise determining the features f.

The step 806 may comprise predicting the noise ϵ_{g} as describe in step 704.

According to the second embodiment, the method comprises a step 808.

The step 808 comprises mapping the features f with the diffusion model 202 as described in step 706.

The step 808 may comprise modulating the features f depending on the condition y as described in step 706.

The output Z₀ may be in image space, i.e., pixel space, or in latent space.

The method according to the second embodiment may comprise a step 810 for mapping the output Z₀ in latent space to the synthetic digital image \tilde{x}.

The synthetic digital image \tilde{x} may comprise the output Z₀ in image space. This means, no decoder 214 is used.

For training, validation, or verification, the method according to the second embodiment may comprise a step 812.

The step 812 may comprise mapping the features f with the feature-based discriminator 300 to the class c.

The step 812 may comprise mapping the synthetic digital image \tilde{x} with the image-based discriminator 400 to the class c.

The method according to the second embodiment may comprise determining the class pixel-wise.

The step 812 may comprise determining the class c for a plurality of outputs of the sequence Z_{T-1}, . . . Z₀ with a respective discriminator depending on features f_{T-1}, . . . f₀ collected from the respective encoding or decoding.

The method according to the second embodiment comprises a step 814.

The step 814 comprises learning at least one parameter of the diffusion model 202 and/or of the feature-based discriminator 300 and/or of the image-based discriminator 400 as described in step 712.

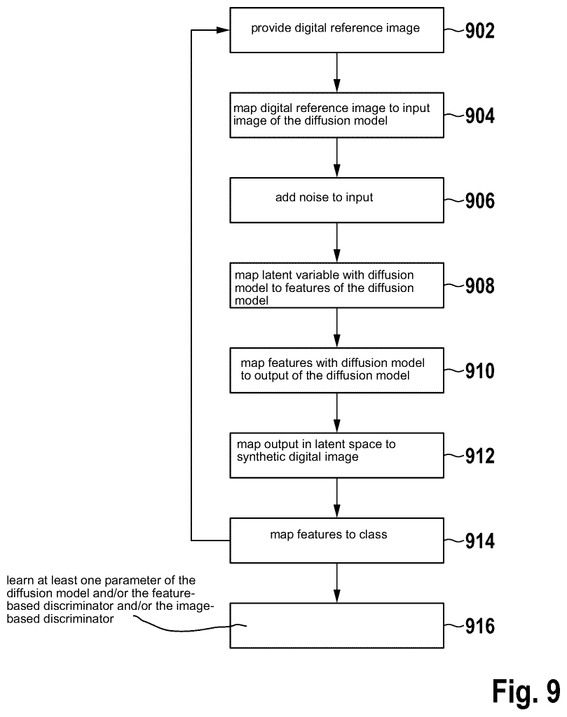

The steps 802 to 812 may be repeated to determine a batch of training data for learning the parameters. The step 814 may comprise learning the parameters e.g., with a gradient descent based on the batch of training data FIG. 9 schematically depicts a flow chart of a third embodiment of the method for generating a synthetic digital image.

According to the third embodiment, the diffusion model comprises the encoder 210 for mapping a digital image to an input x.

According to the third embodiment, the method comprises a step 902.

The step 902 comprises providing the digital reference image 214.

According to the third embodiment, the method comprises a step 904.

The step 904 comprises mapping the digital reference image 204 with the encoder 210 to the input x of the diffusion model 202.

According to the third embodiment, the method comprises a step 906.

The step 906 comprises adding noise with the diffusion model 202 to the input x to determine the latent variable Z_{T}.

According to the third embodiment, the method comprises a step 908.

The step 908 comprises mapping the latent variable Z_{T} as described in step 704.

The step 908 may comprise determining the sequence of outputs Z_{T-1}, . . . Z₀ as described in step 704, wherein encoding or decoding may comprise determining the features f.

The step 908 may comprise predicting the noise ϵᵢ as describe in step 704.

According to the third embodiment, the method comprises a step 910.

The step 910 comprises mapping the features f with the diffusion model 202 as described in step 706.

The step 910 may comprise modulating the features f depending on the condition y as described in step 706.

The output Z₀ may be in image space, i.e., pixel space, or in latent space.

The method according to the third embodiment may comprise a step 912 for mapping the output Z₀ in latent space to the synthetic digital image \tilde{x}.

The synthetic digital image \tilde{x} may comprise the output Z₀ in image space. This means, no decoder 214 is used.

For training, validation, or verification, the method according to the third embodiment may comprise a step 914.

The step 914 may comprise mapping the features f with the feature-based discriminator 300 to the class c.

The step 914 may comprise mapping the synthetic digital image \tilde{x} with the image-based discriminator 400 to the class c.

The method according to the third embodiment may comprise determining the class pixel-wise.

The step 914 may comprise determining the class c for a plurality of outputs of the sequence Z_{T-1}, . . . Z₀ with a respective discriminator depending on features f_{T-1}, . . . f₀ collected from the respective encoding or decoding.

The method according to the third embodiment comprises a step 916.

The step 916 comprises learning at least one parameter of the diffusion model 202 and/or of the feature-based discriminator 300 and/or of the image-based discriminator 400 as described in step 712.

The steps 902 to 914 may be repeated to determine a batch of training data for learning the parameters. The step 916 may comprise learning the parameters e.g., with a gradient descent based on the batch of training data

The method for generating synthetic images as described above may be used for providing a machine learning system. The machine learning system may comprise a neural network for semantic segmentation, object recognition, or classification of objects.

An exemplary computer-implemented method for providing the machine learning system comprises generating a synthetic digital image with the method for generating the synthetic digital image, and training, testing, verifying, or validating the machine learning system depending on the synthetic digital image.

Preferably a plurality of synthetic digital images are determined and the machine learning system is trained, tested, verified or validated depending on the plurality of synthetic digital images.

Depending on the purpose or type of machine learning system that shall be provided, the machine learning system is trained, tested, verified, or validated for semantic segmentation, or object recognition, or classification of objects.

Preferably, the machine learning system is trained, tested, verified, or validated for recognizing background or an object, in particular a traffic sign, a road surface, a pedestrian, a vehicle, an animal, a plant, infrastructure, or the sky, depending on the synthetic digital image.

Training, testing, verifying, or validating the machine learning system may comprise providing the condition y, in particular the label map, that is provided for generating the synthetic digital image as ground truth for training, testing, verifying, or validating the machine learning system.

The diffusion model may be a generative model or part of a generative model to generate training and/or test data for a machine learning system or training and/or test data for an image classifier.

This means, a computer-implemented method for generating the synthetic digital image \tilde{x} with the diffusion model for generating training and/or test data for training a machine learning system or an image classifier comprises sampling an input Z_{T} from a probability distribution, in particular a Gaussian distribution, providing the condition y for the semantic layout of the synthetic digital image \tilde{x}, in text, a class label, a semantic label map, a two-dimensional or a three dimensional pose, or a depth map, and mapping the input Z_{T} with the diffusion model to the output \tilde{x} or \tilde{Z}₀ of the diffusion model, e.g., as described in step 608.

The synthetic digital image \tilde{x} may comprise the output \tilde{x} of the diffusion model, or the synthetic digital image \tilde{x} is generated depending on the output \tilde{Z}₀ of the diffusion model.

The diffusion model is the generative model or part of the generative model to generate training and/or test data for a machine learning system or training and/or test data for an image classifier. The diffusion model comprises the successive levels.

Mapping the input Z_{T} with the diffusion model to the output \tilde{x} or \tilde{Z}₀ may comprise successively determining features f at the levels depending on the input Z_{T}, inputting the condition y to the diffusion model at at least one level of the levels, modulating the features f of at least one level of the levels depending on the condition y, and determining the output \tilde{Z}₀ of the diffusion model depending on the modulated features.

An exemplary computer-implemented method for operating the technical system 112 comprises providing the machine learning system with the method for providing the machine learning system, capturing a digital image with the sensor 108, and determining the control signal for operating the technical system 112 with the machine learning system depending on the digital image.

The methods comprises a generic training paradigm to improve the synthesis quality of the diffusion models, which is particularly useful for conditional diffusion models and improve the conditional alignment. The methods can improve the training of both unconditional and conditional diffusion models, and is independent of the architecture design of the diffusion models. The diffusion model may comprise a denoising model for the denoising process 218, which can be a UNet or a transformer-based model in the pixel space or in the latent space.

For instance, the methods can be applied to improve ControlNet, FreestyleNet, despite they have different designs of the denoising model with conditions. By employing the methods, the synthesized digital images are better aligned with the conditions, e.g., the label map. This is beneficial for downstream applications, since the condition to the generative models will be used as the ground-truth label during training of the downstream task. For instance, when using the synthetic data for augmenting the training of a semantic segmentation network, the label map of the generative model may be reused as the ground-truth label to train the semantic segmentation network. If the synthesized images are not aligned with the conditional inputs, the mismatching will mislead the network training because the ground-truth label is no longer correct anymore.

What is claimed is:

1. A computer-implemented method for generating a synthetic digital image: (i) for generating training data and/or test data for training a machine learning system, or (ii) for training an image classifier, the method comprising the following steps:
providing a latent variable of a diffusion model representing the synthetic digital image, wherein the providing of the latent variable includes: (i) sampling the latent variable from random noise, or (ii) providing a digital reference image, and adding noise with the diffusion model to the digital reference image to determine the latent variable, or (iii) mapping the digital reference image with an encoder to an input of the diffusion model, and adding noise with the diffusion model to the input to determine the latent variable; and
(i) mapping the latent variable with the diffusion model depending on parameters of the diffusion model to features of the diffusion model, mapping the features with the diffusion model depending on parameters of the diffusion model to an output of the diffusion model, wherein the synthetic digital image comprises the output, or (ii) mapping the output with a decoder to the synthetic digital image, mapping the features or the synthetic digital image with a discriminator to a class of a predetermined set of classes for a real digital image or to a class for a synthetic digital image, depending on parameters of the discriminator, and learning at least one parameter of the diffusion model and/or the discriminator depending on a loss for the discriminator that is defined depending on the class and a predetermined reference class.

2. The method according to claim 1, wherein the synthetic digital image includes pixels, and wherein the method further comprises determining the class pixel-wise, and learning the at least one parameter depending on a loss that is defined depending on the pixel-wise classes and respective predetermined pixel-wise reference classes.

3. The method according to claim 1, wherein the method further comprises determining a sequence of outputs comprising the output, wherein determining the sequence of outputs includes determining a first output of the sequence depending on a result of encoding the input and decoding the encoded input, and successively determining a next output in the sequence depending on a result of encoding the output preceding a next output in the sequence and decoding the encoded output preceding a next output in the sequence, wherein encoding or decoding includes determining the features.

4. The method according to claim 3, wherein the method further comprises determining, with a respective discriminator, a class for a plurality of outputs of the sequence depending on features collected from respective encoding or decoding, and learning the parameters depending on losses that are defined for each of the respective discriminators depending on the class predicted by the respective discriminator and the predetermined reference class.

5. The method according to claim 4, wherein the method includes predicting a noise in the next output of the sequence depending on the output preceding the next output in the sequence of outputs, and learning the parameters depending a loss for noise and depending on the losses that are defined for the respective discriminators, wherein the loss for noise is defined depending on the predicted noise and a predetermined random noise sampled from a Gaussian distribution.

6. The method according claim 1, further comprising providing a condition including a label map, modulating the features depending on the condition, and mapping the modulated features: (i) with the diffusion model to the output, and/or (ii) with the discriminator to the class.

7. The method according to claim 6, wherein the method further comprises learning the at least one parameter depending on the loss that is defined for the discriminator, wherein the loss that is defined for the discriminator is defined depending on the condition.

8. The method according to claim 4, further comprising providing a condition including a label map, modulating the features depending on the condition, and mapping the modulated features: (i) with the diffusion model to the output, and/or (ii) with the discriminator to the class, and learning the parameters depending on the losses that are defined for the respective discriminators, wherein the losses are defined depending on the condition.

9. The method according to claim 2, further comprising providing a condition including a label map, modulating the features depending on the condition, and mapping the modulated features: (i) with the diffusion model to the output, and/or (ii) with the discriminator to the class, and wherein the condition comprises the predetermined reference class or the pixel-wise reference classes.

10. A computer-implemented method for providing a machine learning system including a neural network for semantic segmentation, or object recognition, or classification of objects, the method comprising the following steps:
generating a synthetic digital image by:
providing a latent variable of a diffusion model representing the synthetic digital image, wherein the providing of the latent variable includes: (i) sampling the latent variable from random noise, or (ii) providing a digital reference image, and adding noise with the diffusion model to the digital reference image to determine the latent variable, or (iii) mapping the digital reference image with an encoder to an input of the diffusion model, and adding noise with the diffusion model to the input to determine the latent variable, and
mapping the latent variable with the diffusion model depending on parameters of the diffusion model to features of the diffusion model, mapping the features with the diffusion model depending on parameters of the diffusion model to an output of the diffusion model, wherein the synthetic digital image comprises the output; and
training or testing or verifying or validating the machine learning system for semantic segmentation or object recognition or classification of objects, depending on the synthetic digital image.

11. The method according to claim 10, wherein the training or testing or verifying or validating of the machine learning system includes providing a condition including a label map, that is provided for generating the synthetic digital image as ground truth for training, testing, verifying, or validating the machine learning system.

12. A computer-implemented method for operating a technical system, the technical system including a computer-controlled machine the method comprising the following steps:
providing a machine learning system by:
generating a synthetic digital image by:
providing a latent variable of a diffusion model representing the synthetic digital image, wherein the providing of the latent variable includes: (i) sampling the latent variable from random noise, or (ii) providing a digital reference image, and adding noise with the diffusion model to the digital reference image to determine the latent variable, or (iii) mapping the digital reference image with an encoder to an input of the diffusion model, and adding noise with the diffusion model to the input to determine the latent variable, and
mapping the latent variable with the diffusion model depending on parameters of the diffusion model to features of the diffusion model, mapping the features with the diffusion model depending on parameters of the diffusion model to an output of the diffusion model, wherein the synthetic digital image comprises the output, and
training or testing or verifying or validating the machine learning system for semantic segmentation or object recognition or classification of objects, depending on the synthetic digital image;
capturing a digital image with a sensor, the digital image including a video image or a radar image or a LiDAR image or an ultrasonic image or a motion image or a thermal image; and
determining a control signal for operating the technical system with the machine learning system, depending on the digital image.

13. The method according to claim 12, wherein the computer-controlled machine includes a robotic system or a vehicle or a domestic appliance or a power tool or a manufacturing machine or a personal assistant or an access control system.

14. A device, comprising:
at least one processor; and
at least one memory;
wherein the at least one processor is configured to execute instructions for generating a synthetic digital image: (i) for generating training data and/or test data for training a machine learning system, or (ii) for training an image classifier, the instruction, when executed by the at least one processor, causing the device to perform the following steps:
providing a latent variable of a diffusion model representing the synthetic digital image, wherein the providing of the latent variable includes: (i) sampling the latent variable from random noise, or (ii) providing a digital reference image, and adding noise with the diffusion model to the digital reference image to determine the latent variable, or (iii) mapping the digital reference image with an encoder to an input of the diffusion model, and adding noise with the diffusion model to the input to determine the latent variable; and
(i) mapping the latent variable with the diffusion model depending on parameters of the diffusion model to features of the diffusion model, mapping the features with the diffusion model depending on parameters of the diffusion model to an output of the diffusion model, wherein the synthetic digital image comprises the output, or (ii) mapping the output with a decoder to the synthetic digital image, mapping the features or the synthetic digital image with a discriminator to a class of a predetermined set of classes for a real digital image or to a class for a synthetic digital image, depending on parameters of the discriminator, and learning at least one parameter of the diffusion model and/or the discriminator depending on a loss for the discriminator that is defined depending on the class and a predetermined reference class;
wherein the at least one memory is configured to store the instructions.

15. A non-transitory computer-readable medium on which is stored a computer program including computer-readable instructions for generating a synthetic digital image: (i) for generating training data and/or test data for training a machine learning system, or (ii) for training an image classifier, the instruction, when executed by a computer, causing the computer to perform the following steps:
providing a latent variable of a diffusion model representing the synthetic digital image, wherein the providing of the latent variable includes: (i) sampling the latent variable from random noise, or (ii) providing a digital reference image, and adding noise with the diffusion model to the digital reference image to determine the latent variable, or (iii) mapping the digital reference image with an encoder to an input of the diffusion model, and adding noise with the diffusion model to the input to determine the latent variable; and
(i) mapping the latent variable with the diffusion model depending on parameters of the diffusion model to features of the diffusion model, mapping the features with the diffusion model depending on parameters of the diffusion model to an output of the diffusion model, wherein the synthetic digital image comprises the output, or (ii) mapping the output with a decoder to the synthetic digital image, mapping the features or the synthetic digital image with a discriminator to a class of a predetermined set of classes for a real digital image or to a class for a synthetic digital image, depending on parameters of the discriminator, and learning at least one parameter of the diffusion model and/or the discriminator depending on a loss for the discriminator that is defined depending on the class and a predetermined reference class.
